(19) United States
(12) Patent Application Publication
(10) Pub. No.: US 2025/0029134 A1
(43) Pub. Date: Jan. 23, 2025

(54) SYSTEMS AND METHODS FOR MACHINE LEARNING-BASED TARGETED LINK SHARING

(71) Applicant: Capital One Services, LLC, McLean, VA (US)

(72) Inventors: Leeyat Bracha TESSLER, Arlington, VA (US); Joshua EDWARDS, Philadelphia, PA (US); Kevin OSBORN, Newton Highlands, MA (US); Renee GILL, New York, NY (US)

(73) Assignee: Capital One Services, LLC, McLean, VA (US)

(21) Appl. No.: 18/353,242

(22) Filed: Jul. 17, 2023

(51) Int. Cl. G06Q 30/0214; G06N 20/00

(52) U.S. Cl. CPC G06Q 30/0214; G06N 20/00

(57) ABSTRACT

Disclosed are methods and systems for targeted link sharing. For instance, a sharable link may be detected on a sharing user's computing device, and one or more users associated with the sharing user may be determined to be suitable to use the link. For each suitable user, an interaction history of the user, a code use behavior of the user, and information associated with the code are provided as inputs to a trained machine learning system to obtain, as output, a likelihood that the user uses the code. Each suitable user determined to have the output meet a predefined criterion may be included in a list of receiving users for display within a notification on the sharing user's computing device. The link may be distributed to a computing device of at least one receiving user selected from the list to share the link.

### TECHNICAL FIELD

Various embodiments of this disclosure relate generally to techniques for machine learning (ML)-based targeted link sharing, and, more particularly, to systems and methods for determining users associated with a sharing user of a link that are suitable and likely to use a code associated with the link.

### BACKGROUND

Many merchants utilize referral systems, among other similar types of promotional, discount, and/or coupon-related systems. For example, after a user completes a transaction with a merchant, the merchant may provide the user a link that has an associated code to share with other users. The code may be redeemed to apply an offer, deal, promotion, discount, or the like from the merchant. If redeemed, the sharing user may receive a bonus, reward, or other similar incentive. However, the sharing user may not know which other users may be suitable and/or likely to redeem the code.

This disclosure is directed to addressing the above-referenced challenges, among other challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for ML-based targeted link sharing. The methods and systems may include determining users associated with a sharing user of a link that are suitable and likely to use a code associated with the link.

For instance, a computer-implemented method for targeted link sharing, may include detecting a link for sharing on a computing device associated with a sharing user, determining one or more users from a plurality of users associated with the sharing user that are suitable for using a code associated with the link, and for each of the one or more users, providing an interaction history of the respective user, a code use behavior of the respective user, and information associated with the code as inputs to a trained machine learning system, receiving a likelihood that the respective user uses the code as output of the trained machine learning system, and determining whether the output meets a predefined criterion. The method may also include generating a list of receiving users that includes each of the one or more users determined to have the output meet the predefined criterion, generating and providing a first notification including the list for display on the computing device associated with the sharing user, and in response the first notification, receiving a selection of at least a first receiving user and a second receiving user of the one or more receiving users from the list to share the link with. The method may further include determining the code is a non-reusable code, generating and providing a second notification indicating the code is non-reusable, receiving a new link including a new code in response the second notification, and distributing the link to a first computing device associated with the first receiving user and the new link to a second computing device associated with the second receiving user.

A computer-implemented method for targeted link sharing may include detecting a link for sharing on a computing device associated with a sharing user, identifying criteria for using a code associated with the link, and determining one or more users from a plurality of users associated with the sharing user that are suitable to use the link based on the criteria and a plurality of interaction histories of the plurality of users. The method may also include, for each of the one or more users, providing an interaction history of the respective user, a code use behavior of the respective user, and information associated with the code as inputs to a trained machine learning system, receiving a likelihood that the respective user uses the code as output of the trained machine learning system; and determining whether the output meets a predefined criterion. The method may further include generating a list of receiving users that includes each of the one or more users determined to have the output meet the predefined criterion, providing a notification including the list for display on the computing device associated with the sharing user, receiving a selection of at least one of the one or more receiving users from the list to share the link with, and distributing the link to at least one computing device associated with the at least one of the one or more receiving users.

A method for training a machine learning system to predict a likelihood of code use may include receiving a plurality of training datasets associated with a plurality of users. Each of the plurality of training datasets may include an interaction history and a code use behavior of a respective user of the plurality of users, information associated with a past code received by the respective user, and an indication of whether the past code was used. The method may also include providing at least a portion of the plurality of training datasets as input to a machine learning system to train the machine learning system to predict a user-specific likelihood of code use, where responsive to detecting a link including a current code for sharing on a computing device associated with a sharing user, the trained machine learning system may be deployed to predict a likelihood of use of the current code for each of one or more users that are associated with the sharing user and are determined to be suitable to use the code. The method may further include receiving feedback associated with at least one of the one or more users that the sharing user selected to share the current code with, the feedback indicating whether the current code was used, and updating the trained machine learning system based on the feedback.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for link sharing, according to certain embodiments.

FIG. 2 depicts a flowchart of an exemplary process for targeted link sharing, according to certain embodiments.

FIG. 3 depicts a flowchart of another exemplary process for targeted link sharing that takes into account a reusability of the link's code, according to certain embodiments.

FIG. 4 depicts a flowchart of an exemplary process for training a machine learning system to predict a user-specific likelihood of code use, according to certain embodiments.

FIG. 5 depicts a block diagram of an exemplary process for training and using a machine learning system to predict a user-specific likelihood of code use, according to certain embodiments.

FIG. 6 depicts an exemplary targeted sharing notification, according to certain embodiments.

FIGS. 7A and 7B depict exemplary non-reusable link notifications, according to certain embodiments.

FIG. 8 depicts an exemplary shared link notification, according to certain embodiments.

FIG. 9 depicts another exemplary shared link notification, according to certain embodiments.

FIG. 10 depicts an example of a computer, according to certain embodiments.

### DETAILED DESCRIPTION OF EMBODIMENTS

According to certain aspects of the disclosure, methods and systems are disclosed for ML-based targeted link sharing. As will be discussed in more detail below, in various embodiments, systems and methods are described for determining users associated with a sharing user of a link that are suitable and likely to use a code associated with the link.

As briefly discussed above, many merchants utilize referral systems, among other similar types of promotional, discount, and/or coupon-related systems. For example, after a user completes a transaction with the merchant, the merchant may provide the user a link to share with other users (e.g., receiving users). A portion of the link may include a code. The code may be redeemed by a suitable receiving user (e.g., a qualified or eligible receiving user) to apply an offer, deal, promotion, discount, or the like from the merchant. In some examples, if the code is redeemed by one or more suitable receiving users, the sharing user may receive a bonus, reward, or other similar incentive. However, the sharing user may not know which other users are suitable and/or likely to redeem the code, and thus may not be optimally sharing the link.

Systems and methods are described herein for determining, using ML, suitable users associated with the sharing user of the link that are likely to use (e.g., redeem) the code based on their past merchant interaction history and code use behavior in view of information associated with the code at hand. The determined users may be included within a list of receiving users for display to the sharing user. The list may represent a recommendation, for example, of which users to share the link with. The sharing user may select one or more receiving users from the list, and the link may be distributed to computing devices of the respective selected receiving users to share the link.

Additionally, some merchant-provided codes may have use-related terms and conditions. For example, a code may only be used or redeemed a predefined number of times (e.g., the code is a one-time use code, can be used N times, etc.). Resultantly, in instances where the code is limited and multiple receiving users are selected to receive the shared link, once the code is redeemed the predefined number of times by a subset of the receiving users, the code is now invalid to any remaining receiving users. Systems and methods are also described herein for determining non-reusability of a code, and providing proactive and/or reactive notifications to the sharing user to prompt provision of new links with valid codes to distribute to remaining receiving users.

Further, typical conventional link sharing systems may be limited to sharing links through static communication channels, such as electronic mail (e-mail) or text message. Consequently, if users that are receiving the shared link are not interested in the offer, deal, promotion, discount, etc. at that very time, the shared link is likely to become buried amongst other communications, and the receiving users will simply forget that they have the shared link. Systems and methods are further described herein for dynamic display of a shared link notification to a receiving user to increase engagement with the shared link and likelihood of code redemption. As one example, the shared link notification may be displayed in response to detecting navigation to a merchant website associated with the link via a web browser executing on the receiving user's computing device. Additionally or alternatively, the shared link notification may be displayed in response to detecting that search results of a search engine executing on the receiving user's computing device includes the merchant website.

Reference to any particular activity is provided in this disclosure only for convenience and is not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” may convey “based at least in part on.” The singular forms “a,” “an,” and “the” may include plural referents unless the context dictates otherwise. The term “exemplary” may be used in the sense of “example” rather than “ideal.” The terms “comprises,” “comprising,” “includes,” “including,” or other variations thereof, may convey a non-exclusive inclusion such that a process, method, or product that comprises a list of elements does not necessarily include only those elements, but may include other elements not expressly listed or inherent to such a process, method, article, or apparatus. The term “or” may be interpreted disjunctively, such that “at least one of A or B” includes, (A), (B), (A and A), (A and B), etc. Similarly, the term “or” is intended to mean “and/or,” unless explicitly stated otherwise. “And/or” may convey all permutations, combinations, subcombinations, and individual instances of items or terms included within a list of the items or terms. Relative terms, such as, “substantially” and “generally,” may be used to indicate a possible variation of +10% of a stated or understood value.

Terms like “provider,” “merchant,” or the like may generally encompass an entity or person involved in providing, selling, and/or renting items to persons such as a seller, dealer, renter, merchant, vendor, or the like, as well as an agent or intermediary of such an entity or person. An “item” may generally encompass a good, service, or the like having ownership or other rights that may be transferred. As used herein, terms like “account user” or “user” generally encompass any person or entity that may have a link sharing account and consume link sharing services from a provider (e.g., through a link sharing application). The same person or entity may also have a financial account, such as a credit card or debit card account, and consume financial services from a same or different provider (e.g., through a financial application), where interaction history information from the financial account may be associated with the link sharing account. The term “application” may be used interchangeably with other terms like “program,” or the like, and generally encompasses software that is configured to interact with, modify, override, supplement, or operate in conjunction with other software.

A “sharing user” or “referrer” may be a user that is utilizing the link sharing services to share a link associated with a merchant. A “receiving user” or “referee” may be a user that has been selected by the sharing user to receive the link shared by the sharing user, and may be capable of redeeming a code associated with the link. A “link” may generally include a uniform resource locator (URL) to page of a merchant site and a merchant-provided code that may be used or redeemed by the receiving user to apply an offer, promotion, discount, deal, or the like on an item sold by the merchant through the merchant site.

As used herein, a “machine learning model” may generally encompass instructions, data, and/or a model configured to receive input, and apply one or more of a weight, bias, classification, or analysis on the input to generate an output. The output may include, e.g., a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. The training data may be generated, received, and/or otherwise obtained from internal or external resources. Aspects of a machine learning system may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification, or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. Alternatively, reinforcement learning may be employed for training. For example, reinforcement learning may include training an agent interacting with an environment to make a decision based on the current state of the environment, receive feedback (e.g., a positive or negative reward based on accuracy of decision), adjusts its decision to maximize the reward, and repeat again until a loss function is optimized.

In an exemplary use case, certain embodiments may enable ML-based target link sharing. For instance, a sharable link may be detected on a sharing user's computing device. A plurality of users associated with the sharing user (e.g., associated users) may be identified, and a subset of one or more associated users are determined to be suitable (e.g., eligible or qualified) to use a code associated with the link based on criteria for code use. For each suitable user determined, an interaction history of the user, a code use behavior of the user, and information associated with the code may be provided as inputs to a trained machine learning system. The trained machine learning system may provide a likelihood that the user uses the code as output. Each suitable user determined to have the output meet a predefined criterion may be included in a list of receiving users for display within a notification on the sharing user's computing device. The link may be distributed to a computing device of at least one receiving user selected from the list to share the link.

In some examples, a reusability status of the code may be determined prior to distribution. If the code is determined to be non-reusable, then the sharing user may be proactively prompted to provide one or more new links associated with new codes to enable distribution of a different link to each selected receiving user such that redemption of the code by one receiving user will not preclude the other receiving users from redeeming the code. Additionally or alternatively, if the code is determined to be non-reusable, then the sharing user may be reactively prompted to provide one or more new links associated with new codes in response to one of the receiving users redeeming the code, and thus invalidating the code, when at least two or more selected receiving users had been distributed the same link with the now invalid code.

Further, once the link(s) are distributed to the selected receiving users, a shared link notification may be dynamically displayed to a respective receiving user to increase engagement with the link and the likelihood of code use. As one example, the share link notification may be displayed in response to detecting navigation to a merchant site associated with the link via a web browser executing on the receiving user's computing device. As another example, the share link notification may be displayed in response to detecting that search results of a search engine executing on the receiving user's computing device include the merchant site.

While specific examples included throughout the present disclosure involve referral links and associated referral codes, it should be understood that techniques according to this disclosure may be adapted to other types of sharable links having associated codes, such as promotional links, coupon links, and/or other similar offers provided via links. It should also be understood that the examples above are illustrative only. The techniques and technologies of this disclosure may be adapted to any suitable activity.

Presented below are various aspects of machine learning techniques that may be adapted for determining a user-specific likelihood of code use, determining criteria for using a code, and/or determining a reusability status of a code (e.g., whether a code is reusable or non-reusable). As will be discussed in more detail below, the machine learning techniques may include one or more aspects according to this disclosure, e.g., a particular selection of training data, a particular training process for the machine learning system, operation of the machine learning system in conjunction with particular data, modification of such particular data by the machine learning system, etc., and/or other aspects that may be apparent to one of ordinary skill in the art based on this disclosure.

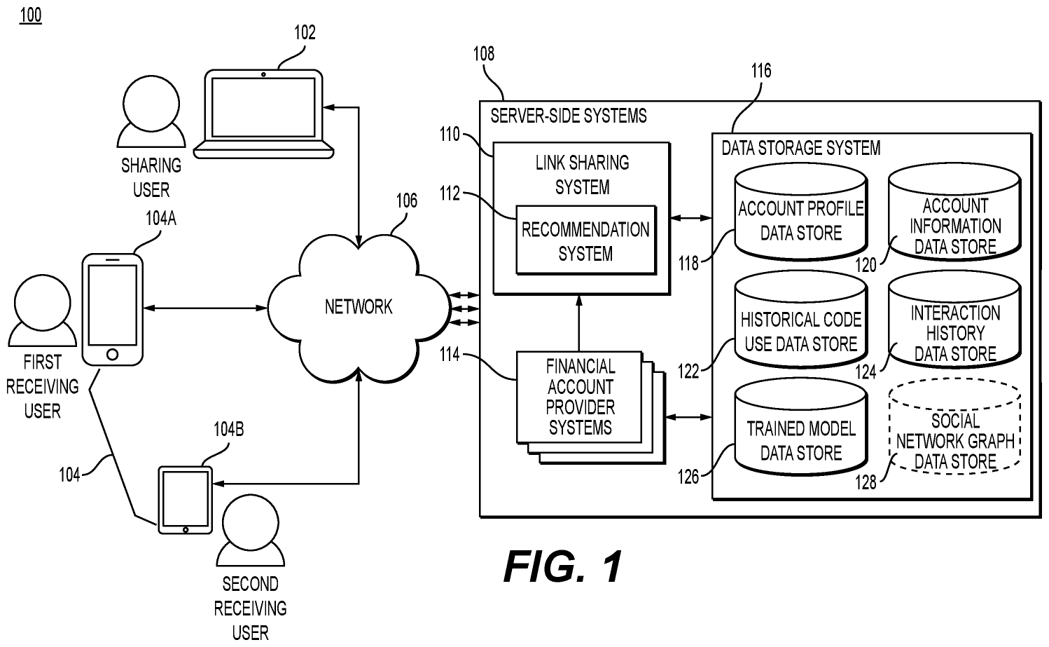

FIG. 1 depicts an exemplary environment 100 for link sharing, according to certain embodiments, and which may be used with the techniques presented herein. A user computing device 102 of a sharing user, hereinafter sharing user computing device 102, may communicate with one or more of the other components of the environment 100 across electronic network 106, including one or more server-side systems 108, discussed below, to share a link with one or more receiving users. Additionally, one or more computing devices 104 of the receiving users, hereinafter receiving user computing devices 104, may communicate with one or more of the other components of the environment 100 across electronic network 106, including the server-side systems 108, to receive and/or engage with the link shared by the sharing user to use an associated code. The environment 100 of FIG. 1 shows a first receiving user computing device 104A of a first receiving user and a second receiving user computing device 104B of a second receiving user. However, in other examples, there may be more or fewer receiving user computing devices 104.

Each of the sharing user and the receiving users may have a respective user account for link sharing services of a provider (e.g., a respective link sharing account). In some examples, the receiving users may be part of a group of users associated with the sharing user (e.g., friends or associates of the sharing user) established via a social network graph maintained as part of the link sharing services, as described in detail elsewhere herein. In other link sharing interactions, the sharing user may be a receiving user of a shared link and/or the receiving users may be a sharing user of a shared link.

The server-side systems 108 may include a link sharing system 110, one or more financial account provider systems 114, and/or a data storage system 116, among other systems. In some embodiments, the link sharing system 110, at least one of the financial account provider systems 114, and the data storage system 116 may be associated with a common entity, e.g., the provider of the link sharing services, or the like. In such an embodiment, the provider may provide link sharing accounts to a plurality of users, financial accounts to a subset of the plurality of users, and data storage services. In such embodiments, the link sharing system 110, the at least one of the financial account provider systems 114, and the data storage system 116 may be part of a cloud service computer system (e.g., in a data center).

In other embodiments, one or more of the components of the environment 100 may be associated with a different entity than another. For example, the link sharing system 110 may be associated with the provider, and one or more of the financial account provider systems 114 may be associated with one or more third parties that provide financial account services to a plurality of users, including subset of users that also have link sharing accounts through the provider. Accordingly, the third parties may provide financial account information for the subset of users, including interaction history data, to the link sharing system 110 to be used for link sharing functionalities, as described in detail below. Additionally or alternatively, data storage system 116 may be associated with a third party that provides data storage services to the provider.

The above-provided examples are exemplary and non-limiting. The systems and devices of the environment 100 may communicate in any arrangement. As will be discussed herein, systems and/or devices of the environment 100 may communicate in order to enable link sharing, among other activities.

Each of the sharing user computing device 102 and the receiving user computing devices 104 may be configured to enable a respective user to access and/or interact with other systems in the environment 100. For example, the sharing user computing device 102 and/or the receiving user computing devices 104 may be a computer system such as, for example, a desktop computer, a laptop computer, a tablet, a smart cellular phone, a smart watch or other electronic wearable, etc. In some embodiments, the sharing user computing device 102 and/or the receiving user computing devices 104 may include one or more electronic application(s), e.g., a program, plugin, browser extension, etc., installed on a memory of the user computing device(s) 102. In some embodiments, the electronic application(s) may be associated with one or more of the other components in the environment 100. For example, a link sharing application associated with the link sharing system 110 may be executed on the sharing user computing device 102 and/or the receiving user computing devices 104 to enable the linking sharing services of the provider. In some examples, the application is a browser extension application that adds functionality, such as link sharing functionalities, to a web browser launched on the sharing user computing device 102 and/or the receiving user computing devices 104. In other examples, the application may be a thick client application that is installed locally on the sharing user computing device 102 and/or the receiving user computing devices 104 (e.g., a desktop application or mobile application). In further examples, the application may be a thin client application (e.g., a web application) that is rendered via the web browser launched on the sharing user computing device 102 and/or the receiving user computing devices 104.

Additionally, one or more components of the sharing user computing device 102 and/or the receiving user computing devices 104 may generate, or may cause to be generated, one or more graphic user interfaces (GUIs) based on instructions/information stored in the memory, instructions/information received from the other systems in the environment 100, and/or the like and may cause the GUIs to be displayed via a display of the sharing user computing device 102 and/or the receiving user computing devices 104. The GUIs may be, e.g., mobile application interfaces or browser user interfaces and may include text, input text boxes, selection controls, and/or the like. The display may include a touch screen or a display with other input systems (e.g., a mouse, keyboard, etc.) for the user to control the functions of the sharing user computing device 102 and/or the receiving user computing devices 104.

The link sharing system 110 may include one or more server devices (or other similar computing devices) for executing link sharing services of the provider. As described in detail elsewhere herein, example link sharing services may include detecting a link that can be shared by the sharing user, determining and providing the sharing user with a list of receiving users that are suitable and likely to use a code associated with the link, and distributing the link to one or more of the receiving users selected by the sharing user (e.g., selected from the list or otherwise). Additional example link sharing services may include monitoring for events that trigger the display of a notification that includes the link to the selected receiving users, tracking use of the codes by the receiving users (e.g., whether the codes are redeemed or not), and/or determining a reusability status of the code separately or in conjunction with the use tracking. In some examples, the link sharing system 110 may include one or more sub-systems for performing different aspects or functions of the link sharing services. As shown, one exemplary sub-system may include a recommendation system 112 for determining the list of receiving users that are suitable and likely to use the code associated with the link. As described elsewhere herein, as part of the determination, the recommendation system 112 may deploy one or more trained machine learning models.

The financial account provider systems 114 may include one or more server devices (or other similar computing devices) for executing financial account services. In some examples, when the provider of the link sharing services also provides financial account services (e.g., the provider is a financial institution), at least one of the financial account provider systems 114 is associated with the provider. Remaining financial account provider systems 114 may be third party providers. In other examples, all of the financial systems may be third party providers. As described elsewhere herein, the financial account services may include issuing financial accounts to users, such as checking/debit card accounts and credit card accounts, and monitoring activities associated with the financial accounts, including interactions (e.g., transactions or purchases between the users and merchants using the accounts), fund transfers, payments, etc., among other services. Data collected from the monitoring, including interaction data, may be stored over time. In some examples, the merchant interactions forming the interaction data may be stored in conjunction with a timestamp indicating a time period associated with the respective interactions. For users having financial accounts with the financial account provider systems 114 that also have link sharing accounts, the financial account provider systems 114 may provide certain types of financial account information, such as the interaction data, to the link sharing system 110 to be associated with the respective link sharing accounts and used by the recommendation system 112 for targeted link sharing, for example. The users may opt in or otherwise provide their consent, permission, or the like to have the interaction data shared with the link sharing system 110 for use in targeted link sharing.

The data storage system 116 may include a server system or computer-readable memory such as a hard drive, flash drive, disk, etc. In some embodiments, the data storage system 116 includes and/or interacts with an application programming interface for exchanging data to other systems, e.g., one or more of the other components of the environment, such as at least the link sharing system 110 and/or one or more of the financial account provider systems 114. In some examples, the data storage system 116 may be a sub-system or component of the link sharing system 110 (e.g., when the data storage system 116 is also provided by the provider rather than a third party).

The data storage system 116 may include and/or act as a repository or source for various types of user account-related data for the link sharing services. For example, the data storage system 116 may include a plurality of data stores, including an account profile data store 118, an account information data store 120, a historical code use data store 122, an interaction history data store 124, and/or a trained model data store 126, among other data stores. Additionally, when the link sharing system 110 includes a social network graph that facilitates and captures relationships or associations between user accounts, the data storage system 116 may include optional social network graph data store 128. In some examples, the data stores 118, 120, 122, 124, 126, 128 may store the various types of link sharing account-related data in association with an identifier of each link sharing account (e.g., an account number, user name, or other similar identifier).

The account profile data store 118 may store profile information for each of the plurality of link sharing accounts. The profile information may include account identifiers (e.g., an account number), user information (e.g., name, contact information, QR codes, or other unique identifiers associated with the user), and/or account preferences of the user, among other similar information (e.g., preferences for receiving notifications). The account information data store 120 may include link sharing interactions associated with each of the link sharing accounts. Exemplary interactions may include shared links, forwarded or downstream shared links, received rewards, redeemed rewards, received links, and/or redeemed links, among other similar interactions.

The historical code use data store 122 may store data associated with code use behavior of each user of the link sharing accounts. For example, for a given account, the data stored may include information associated with past codes received and an indication of whether the past codes are used or redeemed. The past codes may be associated with a timestamp indicating a time at which the past links associated with the past codes were received by the respective user. In some examples, the historical code use data store 122 may retrieve at least portions of the code use behavior data from the account information data store 120.

The interaction history data store 124 may store interaction data received from the financial account provider systems 114. For example, for a given link sharing account of a user, interaction data from one or more financial accounts of the user are received and stored in association with the link sharing account (e.g., as an interaction history of the user). The stored interaction history may include information associated with a timing of interactions, a frequency of interactions, or a proportion of interactions among a plurality of merchants and/or categories of merchants.

The trained model data store 126 may store one or more trained models that are retrieved and executed by the recommendation system 112 to facilitate targeted link sharing. The trained models may include at least a first machine learning model trained to predict user-specific likelihood of using a code associated with the link. In some examples, the trained models may also include a second machine learning model trained to predict a criteria associated with use of the code. Additionally or alternatively, the trained models may include a third machine learning model trained to predict a reusability status of the code (e.g., whether the code is reusable).

The optional social network graph data store 128 may store the social network graph. The social network graph may include nodes representing each of the link sharing accounts and edges between various nodes that indicate a relationship (e.g., an association or friendship) between the link sharing accounts represented by the nodes connected by the edges. In examples where the link sharing system 110 does not utilize a social network graph, information from the account profile data store 118 may alternatively be utilized to facilitate link sharing among the users (e.g., the account profile data store may serve as a lookup data store) as described in detail elsewhere herein.

The network 106 over which the one or more components of the environment 100 communicate may include one or more wired and/or wireless networks, such as a wide area network (“WAN”), a local area network (“LAN”), personal area network (“PAN”), a cellular network (e.g., a 3G network, a 4G network, a 5G network, etc.) or the like. In some embodiments, the network 106 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page”, “webpage”, or “page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. The sharing user computing device 102, the receiving user computing devices 104, and one or more of the server-side systems 108 may be connected via the network 106, using one or more standard communication protocols. The sharing user computing device 102, the receiving user computing devices 104, and one or more of the server-side systems 108 may transmit and receive communications from each other across the network 106, as discussed in more detail below.

Although depicted as separate components in FIG. 1, it should be understood that a component or portion of a component in the system of exemplary environment 100 may, in some embodiments, be integrated with or incorporated into one or more other components. For example, at least one of the financial account provider systems 114 and/or data storage system 116 may be integrated with the link sharing system 110 (e.g., to form a larger system of the provider) or the like. In some embodiments, operations or aspects of one or more of the components discussed above may be distributed amongst one or more other components. Any suitable arrangement and/or integration of the various systems and devices of the exemplary environment 100 may be used.

In the following disclosure, various acts may be described as performed or executed by a component from FIG. 1, such as the sharing user computing device 102, the receiving user computing devices 104, or one or more of the server-side systems 108, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

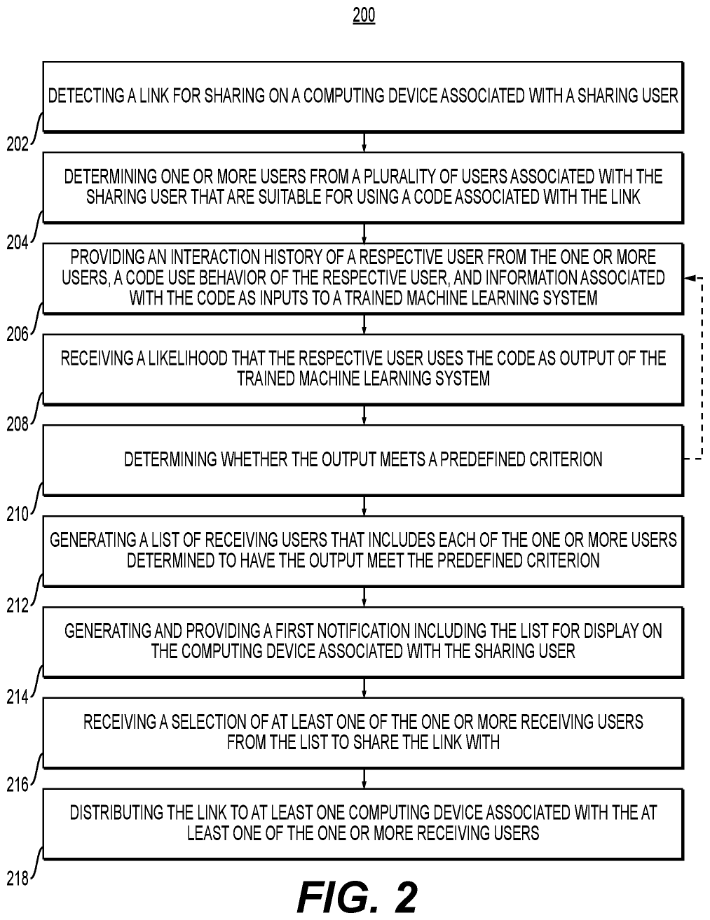

FIG. 2 depicts a flowchart of an exemplary process 200 for targeted link sharing, according to certain embodiments. In some examples, various steps of the process 200 may be performed by the link sharing system 110 and/or, more specifically, the recommendation system 112.

At step 202, the process 200 may include detecting a link for sharing on a computing device associated with a sharing user (e.g., on the sharing user computing device 102). The link may be provided by a merchant. In some examples, the link may be a referral link. In other examples, the link may be a promotional link, a coupon link, or other similar link. The link may be associated with a code. In some examples, the code may form a portion of the link. For example, the link may include a uniform resource locator (URL) to a webpage of the merchant site and the code. The code may be used or redeemed to obtain a promotion, offer, discount, or other similar deal from the merchant. The code may also be associated with the sharing user. For example, the code may be a unique string of characters assigned to the sharing user.

Once shared, the link may allow receiving users of the link to navigate to the webpage of the merchant site and perform one or more actions to use the code, if the receiving users are suitable (e.g., eligible) to use the code. In some examples, the sharing user may receive a bonus, reward, or other similar offer if one or more of the receiving users use the code included in the link shared by the sharing user (e.g., tracked via the association of the code with the sharing user). Therefore, it may be optimal for the sharing user to share the link with receiving users that are suitable and most likely to use or redeem the code. Additionally, downstream bonuses, rewards, or other similar offers may be available to the sharing user if one of the receiving users that redeems the code also shares a link associated with the merchant that is redeemed. Therefore, in some instances, it may be further optimal to share the link with those receiving users who are likely to continue the sharing (e.g., the referral) process.

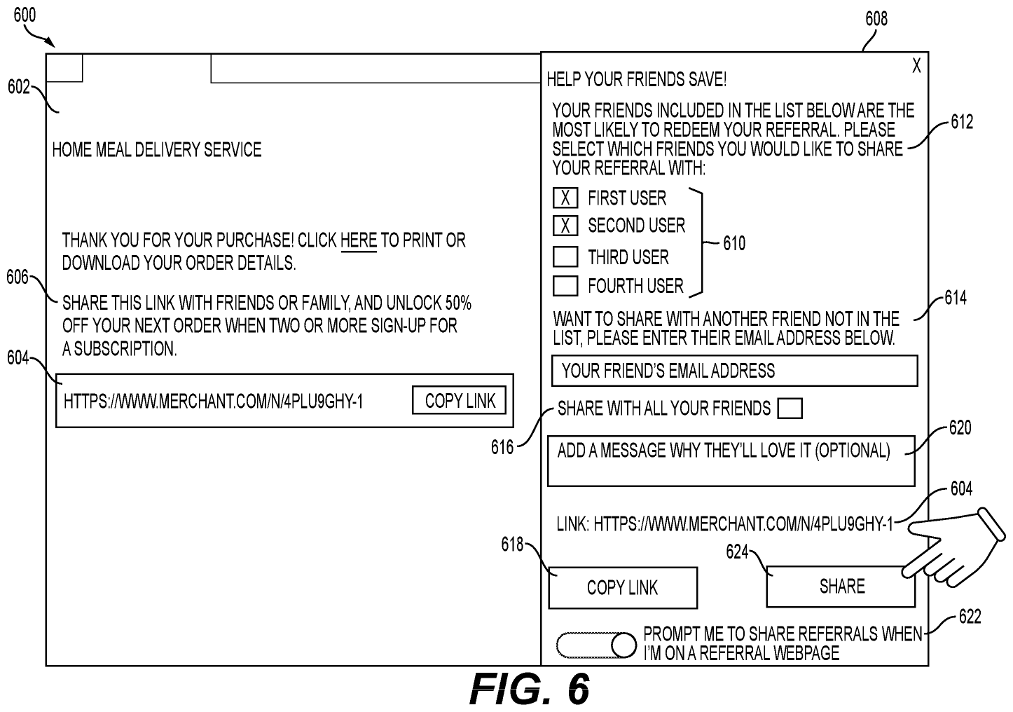

In one example, the link detected at step 202 may be detected on a webpage, such as a referral page (e.g., when the link is a referral link) of the merchant site that is navigated to via the web browser on the sharing user computing device 102. To provide an illustrative example, the merchant may be a home meal delivery service provider, and the sharing user may have purchased a premium level subscription to the home meal delivery service through the merchant site. Upon completing the purchase, the sharing user may be directed to the referral page. An exemplary referral page is shown in FIG. 6. The referral page may include the link for the sharing user to share with others (e.g., to refer to others). As one example, the code associated with the link may be redeemed by a referee to get a free item upon purchasing a premium level subscription.

In another example, the sharing user may receive an electronic communication, such as an e-mail, from the merchant that includes the link. When the sharing user navigates, via the web browser, to a web-based communication application configured to receive and display electronic communications, such as the e-mail, the link may be detected at step 202 upon the user opening the e-mail.

At step 204, the process 200 may include determining one or more users from a plurality of users associated with the sharing user that are suitable for using a code associated with the link. In some examples, the plurality of users associated with the sharing user, also referred to herein as associated users, may be a group of users with link sharing accounts that have established a relationship with the sharing user. For example, any user having a link sharing account may request to be friends or associates with any other user having a link sharing account. The relationship may be captured via a social network graph provided and maintained by the link sharing system 110. In such examples, the social network graph stored in the optional social network graph data store 128 may be queried to identify the associated users. In other examples, the associated users may include all other users having link sharing accounts.

Once the associated users have been identified, the determination of which of the associated users are suitable for using the code may include identifying criteria for using a code associated with the link, and comparing the identified criteria to a plurality of interaction histories of the plurality of users. A “suitable user” may include any of the associated users that are eligible or otherwise qualified to use the code based on the criteria for code use.

Non-limiting exemplary criteria for code use may include that the user has had no previous interaction history with the merchant, no interaction history with the merchant within a predefined period of time, no interaction history with the merchant with respect to an item associated with the code, or no previous use of an offer associated with the code. To continue with the illustrative example where the merchant is the home meal delivery service provider, criteria for the use or redemption of the code may be that the user has not previously subscribed or signed up for any type or level of the home delivery service (e.g., the user is a first time user). As another example, the criteria may be that the user has not subscribed or signed up for any type or level of the home delivery service within the past year. As yet another example, the criteria may be that the user has not previously subscribed or signed up for the particular premium level of subscription associated with the code. As a further example, the criteria may be that the user has not previously redeemed a free item for subscribing to the home delivery service through a referral link sent by a different sharing user, for example.

In some examples, to identify the criteria for code use, one or more terms and conditions associated with the code may be parsed. For example, at least a portion of the terms and conditions associated with qualifications or eligibility for use or redemption of the code by a given user may be identified and extracted.

In other examples, a second trained machine learning system may be used to predict the criteria. Specifically, the second trained machine learning system may be used to predict whether a given user meets the criteria, and is a suitable user. In one example, a browsing history of the user with the merchant site, an interaction history of the user with the merchant, code use behavior of the user specific to codes associated with the merchant, and/or information associated with the codes may be provided as input to the second trained machine learning system. The second trained machine learning system may be trained to process the inputs to output a likelihood of whether the user will be able to use or redeem the code (e.g., whether the user is a suitable user). In some examples, the output may be a binary decision (e.g., yes or no). For example, the output of the second trained machine learning model may be a probability (from 0 to 1) that the user will be able to use or redeem the code. A predefined threshold can then be applied to yield the binary decision of yes, the user will be able to successful use or redeem the code, or no the user will not. For example, if the predefined threshold is 0.5, a probability less than 0.5 yields a prediction of no, the user will not be able to use or redeem the code, and a probability equal to or greater than 0.5 yields a prediction of yes.

In another example, the same or similar inputs may be provided to the second trained machine learning system along with a set of one or more standard terms and conditions, where the second trained machine learning system may be trained to process the inputs to output a likelihood of the one or more standard terms and conditions being applicable to each user. For example, one of the standard terms and conditions may be that the user is a “new user” and the second trained machine learning system may output a likelihood that the user is a new user (e.g., has had no previous interaction history with the merchant). The outputs of the second machine learning system may be used in conjunction with at least the portion of the terms and conditions that are identified and extracted via as the criteria for code use to filter out the users that are predicted to not align with the criteria (e.g., when standard terms and conditions corresponding to the criteria are predicted to be non-applicable to the user).

In instances where no such criteria is identified (e.g., there is no eligibility or qualifications tied to use of the code), all associated users may be suitable users, and the process 200 may proceed to step 208. Otherwise, once the criteria is identified, a determination of whether each of the associated users is suitable to use the code may be made. The determination may be based on a comparison of the criteria to interaction histories of the associated users. The interaction history for each associated user may be received from the interaction history data store 124. For example, when each user establishes a link sharing account, the user may authorize the link sharing system 110 to request information, such as the user's interaction history, from the user's financial account provider system 114 on the user's behalf. Upon receipt, the link sharing system 110 may associate the user's interaction history with the user's link sharing account (e.g., using an identifier of the link sharing account) for storage in the interaction history data store 124. The user's interaction history may be updated periodically and/or updated each time the user is determined to be an associated user of a sharing user, and thus is a potential candidate for receiving the link to be considered as part of the recommendation process.

The interaction history for each associated user may include information associated with interactions between the respective user and a plurality of merchants, including a timing of interactions, a frequency of interactions, and/or a proportion of interactions among merchants and/or merchant categories. For purposes of step 206, the user's interaction history may be queried for interactions between the user and the merchant associated with the link. Results of the query may be analyzed in view of the criteria to determine the user's suitability. For example, if the criteria to use the code includes no previous interaction history between the merchant and the user, and the results of the query indicate at least one previous interaction, the user is determined to not be suitable, and is eliminated (e.g., is not further considered or analyzed) in subsequent steps of the process 200. For associated users that are determined to be suitable to use the code, a determination of which of those suitable users are likely to use the code is made by performing steps 206, 208, and 210. When at least two or more users are determined to be suitable to use the link, steps 206, 208, and 210 may be performed (e.g., repeated) for each suitable user.

For example, at step 206, the process 200 may include providing the interaction history of a respective user from the one or more users determined to be suitable at step 204, a code use behavior of the respective user, and information associated with the code as inputs to a trained machine learning system (e.g., the first trained machine learning system). As previously discussed, the interaction history may include past interactions between the respective user and a plurality of merchants, including a timing of interactions, a frequency of interactions, and/or a proportion of interactions among the merchants. Processing of the interaction history data by the trained machine learning system may indicate spending patterns or habits of the respective user that may be leveraged to predict a likelihood that the respective user will use the code. For example, data associated with the timing and/or frequency of interactions may indicate trends, patterns, etc. in user spending with respect to different types of merchants. As one example, the interaction history may reveal that the respective user frequents eating places and restaurants several times a week. Additionally, data associated with the proportion of interactions also indicate which specific merchants the user prefers or tends to interact with, and thus is likely to continue interacting with. Further, in some examples, the merchants may be classified into different categories based on the types of items they sell, among other characteristics, and a code may be associated with each category (e.g., merchant category codes). Accordingly, the proportion of interactions may also show a proportion of interactions among the categories. For example, the proportion may indicate that the respective user generally has a higher number of interactions with restaurants than clothing retailers, and thus the respective user may generally be more inclined to spend money on food-related items than on clothing.

The code use behavior of the respective user may include information associated with past codes received by the respective user through the link sharing system 110 and an indication of whether the past codes are used. The code use behavior may collected by the link sharing system 110 and stored in the historical code use data store 122 for subsequent retrieval and use as a subset of the inputs to the trained machine learning system. Exemplary information associated with the past codes may include merchants associated with the past codes, items associated with the past codes, offers (e.g., deals, promotions, coupons, etc.) associated with the past codes, sharing users that shared the past codes, a total number of the past codes received, a total number of past codes used, a timing of or frequency at which the past codes were used, a number of times the respective user further shared the past codes to other users, and/or a number of the other users that used the past codes further shared by the respective user. The information associated with the past codes in conjunction with the indication of whether the past codes were used may be processed by the trained machine learning system to identify code use patterns of the respective user that may be leveraged to predict a likelihood that the respective user will use the code.

The information associated with the code, also referred to herein as current code information, may include the merchant, item, offer (e.g., deals, promotions, coupons, etc.), and/or the sharing user associated with the code. The information associated with the merchant may include the specific merchant itself and/or an associated merchant category (e.g., merchant category code). Similarly, the information associated with the item may include the specific item (e.g., a meal subscription box) and/or a categorical type of item (e.g., food) associated with the code. In view of the patterns identified from the processing of the respective user's interaction history and code use behavior, the trained machine learning system may predict a likelihood that the respective user uses the code based on the current code information (e.g., predicts a user-specific likelihood of code use).

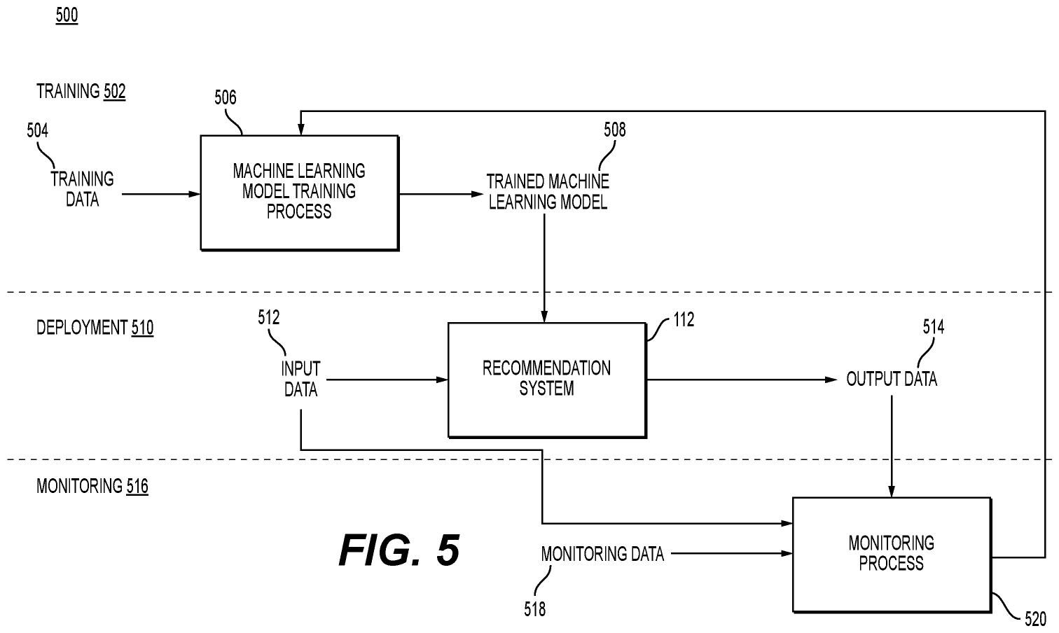

At step 210, the process 200 may include receiving the likelihood that the respective user uses the code as output of the trained machine learning system. As described in more detail with reference to FIG. 5, the predicted likelihood may be a percentage and/or a value between 0 and 1, where the higher the value, the higher the likelihood that the respective user will use the code.

At step 212, the process 200 may include determining whether the output meets a predefined criterion. In one example, the predefined criterion may be a predicted likelihood of code use that meets or exceeds a predefined threshold (e.g., meets or exceeds 0.75 or 75%). In such examples, the determination at step 212 may include a comparison of the output to the predefined threshold to determine whether the likelihood that the respective user uses the code meets or exceeds the predefined threshold. In another example, the predefined criterion may be a predefined number (N) of suitable users having the highest predicted likelihood of code use (e.g., the top 5 suitable users). In such examples, the determination at step 212 includes a comparison of the output received from the trained machine learning system for each of the suitable users to determine whether the likelihood that the respective user uses the code is a top N^{th} likelihood among the other suitable users.

If the output associated with the respective user does not meet the predefined criterion, the respective user may be eliminated (e.g., is not further considered or analyzed) in subsequent steps of the process 200. Otherwise, if the output associated with the respective user meets the predefined criterion, respective user may be recommended to the sharing user to promote targeted link sharing.

For example, at step 212, the process 200 may include generating a list of receiving users that includes each of the one or more users determined to have the output meet the predefined criterion. At step 214, the process 200 may include generating and providing a first notification including the list for display on the sharing user computing device 102. In some examples, the first notification may be a push notification that is displayed via the link sharing application on the web browser executing on the sharing user computing device 102. In other examples, the first notification may be an electronic communication, a text message, or other similar notification. An exemplary first notification is shown in FIG. 6.

At step 216, the process 200 may include receiving a selection of at least one of the one or more receiving users from the list to share the link with. At step 218, the process 200 may include distributing the link to at least one computing device associated with the at least one of the one or more receiving users (e.g., to one of receiving user computing devices 104). Distribution of the link may include association of the shared link with the receiving users' link sharing accounts. Accordingly, when the receiving users access their link sharing accounts (e.g., through the link sharing application) and request to view shared links, the application displays the link shared by sharing user. Additionally, the link sharing system 110 may send an electronic communication, push notification, text message, or other similar communication to the receiving user upon distribution to indicate that the link has been shared.

Further, to increase a likelihood of engagement with the shared link and use of the code, the link sharing system 110 may monitor the online activity of the receiving users, and cause dynamic display of a shared link notification in response to detecting particular online events. The shared link notification may indicate to the receiving user the availability of the shared link and include the link itself, among other details, to prompt use or redemption of the code associated with the link.

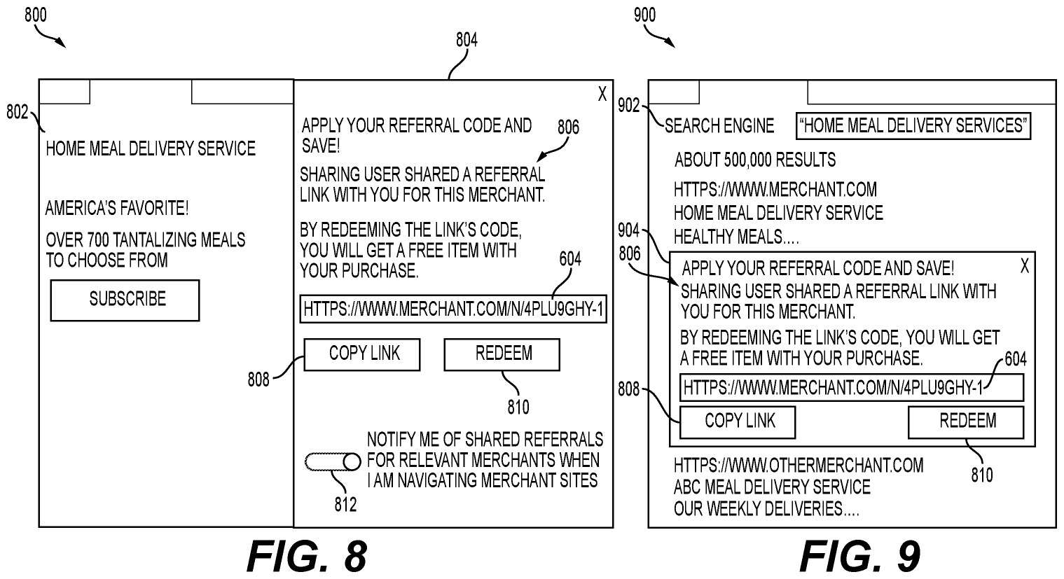

In one example, the link sharing system 110 may detect navigation to the merchant website associated with the link via a web browser executing on one of the receiving user computing devices 104. In such examples, the shared link notification may be a push notification displayed via the web browser, such as the exemplary notification shown in FIG. 8. In another example, the link sharing system 110 may detect that search results of a search engine executing on one of the receiving user computing devices 104 include the merchant site. In such examples, the shared link notification may be embedded within the search results in association with merchant site, such as the exemplary notification shown in FIG. 9. In the above scenarios, the receiving user may already be in a mindset to interact with the merchant and thus may be more likely to use and/or redeem the code associated with the shared link. Other similar online events that are indicative of user interest and/or engagement may be detected and used to trigger the display of the shared link notification.

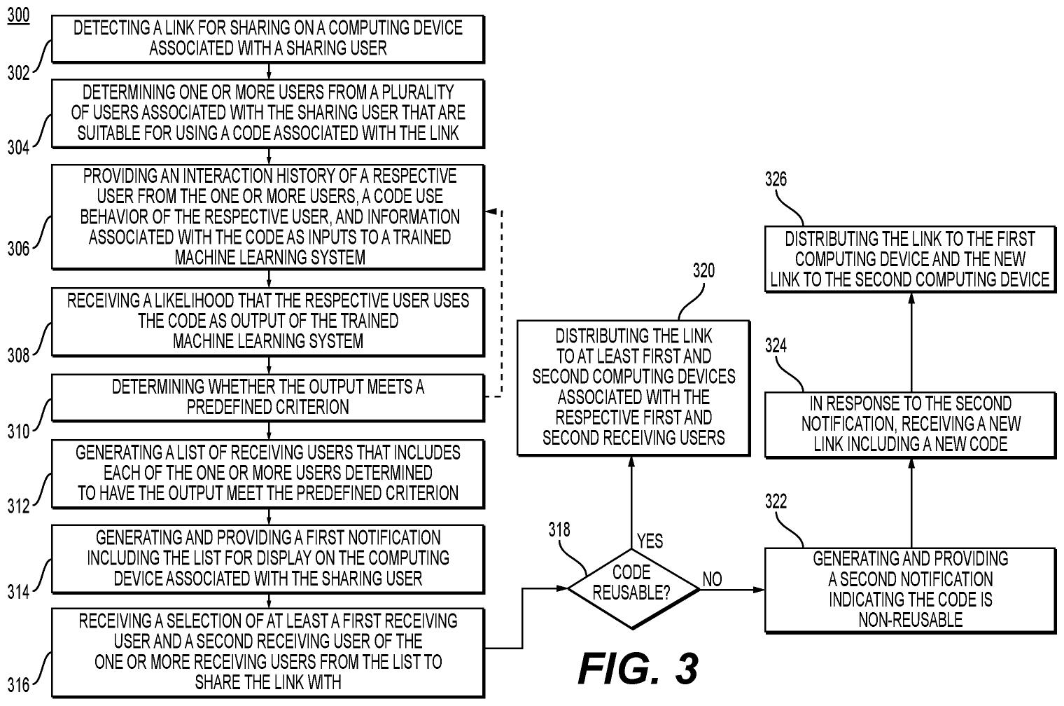

Once the link has been distributed to the receiving users, the link sharing system 110 may be configured to track use or redemption of the code associated with the link. In some examples, the sharing user may receive a bonus, reward, or other similar offer if one or more receiving users use or redeem the code included in the link shared by the sharing user. In such examples, the link sharing system 110 may track use or redemption of the code associated with the link, and credit the sharing user. As previously discussed, the code associated with the link may be a unique value that is assigned to the sharing user to facilitate such crediting upon detected use of the code. Additionally, the link sharing system 110 may generate and provide a code redemption notification to the sharing user computing device 102 to indicate the use of the code. Further, and as discussed in more detail below with reference to FIG. 3, in instances where the code is non-reusable (e.g., the code is a one-time use code) and/or has a limited number of uses (e.g., 5 uses), the tracking may further be used to determine when the code is no longer valid or has expired based on use.

Accordingly, certain embodiments may perform targeted link sharing. The process 200 described above is provided merely as an example, and may include additional, fewer, different, or differently arranged steps than depicted in FIG. 2.

FIG. 3 depicts a flowchart of another exemplary process 300 for targeted link sharing that takes into account a reusability of the link's code, according to certain embodiments. In some examples, various steps of the process 300 may be performed by the link sharing system 110 and/or, more specifically, the recommendation system 112. Process 300 may include similar steps to steps of the process 200. For example, steps 302-316 of the process 300 may be the same or similar to steps 202-216 of the process 200, described in detail above with reference to FIG. 2. Specifically, steps 302, 304, 306, 308, 310, 312, 314, and 316 of the process 300 may correspond respectively to steps 202, 204, 206, 208, 210, 212, 214, and 216 of the process 200. However, at step 316, at least two receiving users (e.g., a first receiving user and a second receiving user) are received as a selection from the list to share the link, causing additional steps to be performed.

For example, at step 318, the process 300 may include determining whether the code associated with the link is reusable. For example, one or a combination of techniques, may be performed to determine a type of the code, including a reusability of the code. The code may be non-reusable (e.g., a one-time use code) or reusable. If the code is reusable, the number of uses may be limited or unlimited. According to a first technique, the terms and conditions associated with the code may be parsed to determine the type of code. In some examples, the parsing of the terms and conditions that may be performed as part of step 304 (corresponding to step 204) to identify criteria for using the code may also yield the information needed to determine the type of code (e.g., a single parsing step may be performed as opposed to two separate parsing steps).

According to a second technique, a third trained machine learning system may be applied to predict a likelihood that the code is a reusable code. For example, an identifier of the merchant and information associated with the code may be provided as inputs to the third trained machine learning system, where the third trained machine learning system may be trained to process the inputs to output a likelihood (e.g., a probability from 0 to 1) that the code is reusable. In some examples, the output may be a binary decision (e.g. yes or no), where a predefined threshold can be applied to yield the binary decision of yes, the code is reusable, or no the code is non reusable. For example, if the predefined threshold is 0.5, a probability less than 0.5 yields a prediction of no, and a probability equal to or greater than 0.5 yields a prediction of yes. Additionally or alternatively, natural language processing (NLP) techniques may be applied to the webpage of the merchant site rendering the code (e.g. the referral webpage). For example, semantic techniques may be applied to recognize whether or not the code is likely to be reusable and/or entity recognition techniques may be applied to recognize a number of times that the code may be reused.

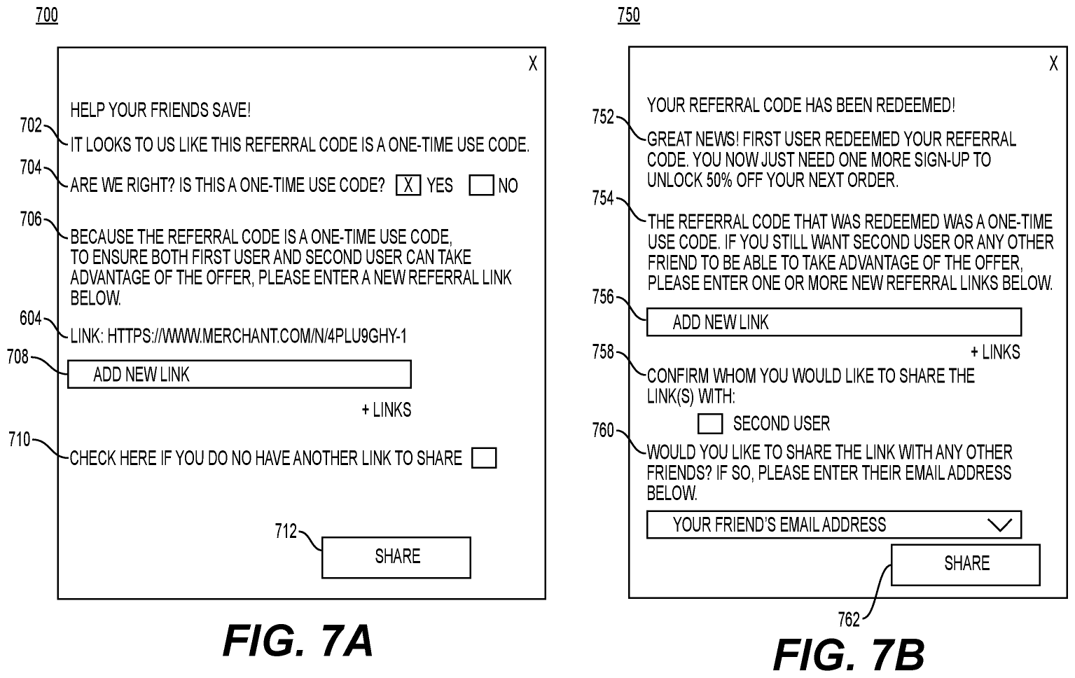

According to a third technique, the link sharing system 110 may receive an indication of the reusability of the code (e.g., whether the code is a reusable code or not) as input from the sharing user in response to a prompt generated by the link sharing system 110 and provided for display on the sharing user computing device 102. For example, the prompt may be included as part of the first notification generated and provided at step 314 and/or a second notification described in detail below. In some examples, when the first and/or second technique is performed in conjunction with the third technique, the prompt may include the type of code determined from the parsing and/or the predicted reusability of the code output from the third trained machine learning system, and ask for the sharing user to confirm the determination and/or prediction, as shown in FIG. 7A.

If at step 318, the code is determined to be reusable, the process proceeds to step 320. At step 320, the process 300 includes distributing the link to at least first and second computing devices associated with the respective first and second receiving users (e.g., first receiving user computing device 104A and second receiving user computing device 104B). If at step 320, the code is determined not to be reusable (e.g., the code is non-reusable), the process proceeds to step 322. Additionally, in some examples, if the code is reusable but the number of uses is limited, the process may also proceed to step 322. For example, if the number of receiving users selected is greater than the number of uses, then the code may be treated similarly as a non-reusable code.

At step 322, the process 300 includes generating and providing a second notification indicating the code is non-reusable. The second notification may be provided for display on the sharing user computing device 102. Because the code associated with the link is non-reusable, if the same link was provided to each receiving user (e.g., to both the first receiving user and the second receiving user), the redemption of the code by the first receiving user would invalidate the code, and effectively block or prevent the second receiving user from being able to redeem the code. Therefore, in addition to indicating the code is non-reusable, the second notification may include a prompt for the sharing user to proactively provide one or more new links associated merchant (e.g., depending on a number of receiving users selected) such that each of the receiving users may receive a unique link and code to allow each receiving user to be able to redeem the code, if desired. An exemplary second notification is shown in FIG. 7A.

At step 324, the process 300 may include receiving a new link including a new code in response to the second notification. For example, based on the sharing user's interactions with the merchant, the sharing user may have accrued multiple referral or other similar links associated with the merchant to share with other users. The new link may be one of those accrued links. In some examples, the link sharing system 110 may be configured to save the accrued links in association with the sharing user's link sharing account, and may automatically select the new link from the saved links upon a request from the sharing user to add the new link. At step 326, the process 300 includes distributing the link to the first computing device (e.g., first receiving user computing device 104A) and the new link to the second computing device (e.g., second receiving user computing device 104B).

Steps 322 through 326 of the process 300 describe proactive distribution of unique links and codes to each receiving user in response to determining the code is non-reusable and more than one receiving user has been selected. In other examples, the distribution of unique links and codes may be reactive. For example, the second notification indicating the code is non-reusable and prompting provision of new links may be generated and provided in response to one of the receiving users redeeming the code, and thus invalidating to code, that was shared with each of the receiving users. In such examples, when one or more new links are received and distributed to the computing devices of the one or more of the other receiving users, the new links may replace the links originally distributed. An exemplary reactive second notification is shown in FIG. 7B.

Accordingly, certain embodiments may perform target link sharing that takes into account a reusability of the link's code. The process 300 described above is provided merely as an example, and may include additional, fewer, different, or differently arranged steps than depicted in FIG. 3.

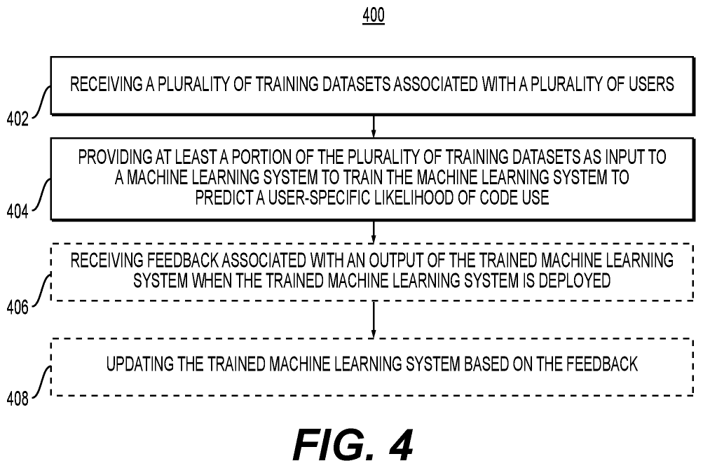

FIG. 4 depicts a flowchart of an exemplary process 400 for training a machine learning system (e.g., the first trained machine learning system) to predict a user-specific likelihood of code use, according to certain embodiments. In some examples, the process 400 may be performed by the link sharing system 110 and/or the recommendation system 112. In other examples, the process 400 may be performed by a third party that provides the trained machine learning system to the recommendation system 112 for execution, as described in more detail below with reference to FIG. 5.

At step 402, the process 400 may include receiving a plurality of training datasets associated with a plurality of users. The plurality of users may each have link sharing accounts with the link sharing system 110. Each training dataset of the plurality of training datasets may be associated with a shared link received by a respective user in the past. Therefore, two or more of the training datasets may be associated with a same user of the plurality users if the user has received two or more shared links in the past. An exemplary training dataset associated with a shared link received by a respective user may include code information for a code associated with the link, an interaction history of the respective user prior to a time the shared link was received, and a code use behavior of the respective user prior to the time the shared link was received. The training set may also include a label that indicates whether the respective user actually used the code associated with the shared link (e.g., a label of 1 if used or 0 if did not).

At step 404, process 400 may include providing at least a portion of the plurality of training datasets as input to a machine learning system to train the machine learning system to predict a user-specific likelihood of code use. For example, the machine learning system may include a machine learning model that is trained to solve a classification problem (e.g., whether code will be used or not). As described in more detail with reference to FIG. 5, for each training dataset associated with the shared link received by the respective user in the past provided as input, the code information for the code associated with the shared link, as well as the interaction history and code use behavior of the respective user prior to the time the shared link was received are provided as inputs to the model. The machine learning model may predict the likelihood of the respective user using the code based on the inputs. The predicted likelihood may be a probability (e.g., from 0 to 1) that the respective user will use the code. The label from the dataset indicating whether the respective user actually used the code (e.g., the label of 0 or 1) may be used to determine an error, which may then be used to modify or tune one or more aspects of the machine learning model, such as the weights and bias, for forming the classifications.

In some examples, a trained machine learning model common to the plurality of users may be generated. In other examples, a separate, user-specific trained machine learning model may be generated for one or more of the plurality of users (e.g., when sufficient training data is available for the users).

Once trained, the trained machine learning system may be stored in the trained model data store 126, and subsequently retrieved for execution by the recommendation system 112 as part of the process flow for targeted link sharing (e.g., associated with steps 206 and 208 of the process 200 and steps 306 and 308 of the process 300). For example, responsive to detecting a link including a current code for sharing on the sharing user computing device 102, the trained machine learning system may be deployed to predict a likelihood of use of the current code for each of one or more users that are associated with the sharing user and are determined to be suitable to use the code. For each of the suitable users, the interaction history and code use behavior of the respective user up to the current time are provided, along with the current code information, as inputs to the trained machine learning system for processing. In examples where a trained machine learning model common to the plurality of users is generated, the inputs for each suitable user may be individually provided to the same common model. In examples where separate, user-specific trained machine learning models are generated, each model may be stored in association with an identifier of the user, and models corresponding to the users can be retrieved. The interaction history and code use behavior specific to each suitable user, along with the current code information, may then be provided as inputs to the corresponding model for the respective suitable user.

At optional step 406, process 400 may include receiving feedback associated with an output of the trained machine learning system when the trained machine learning system is deployed. For example, the output of the trained machine learning system may predict a 0.85 or 85% likelihood of code use by a respective user. The feedback may indicate whether or not the respective user actually redeemed the code or not.

At optional step 408, process 400 may include updating the trained machine learning system based on the feedback. For example, the feedback may be used as a label to create a new training dataset for use in retraining the machine learning model of the machine learning system. Resultantly, one or more aspects of the trained machine learning model, such as the weights and bias, may be further modified or tuned for improved accuracy of the model. In some examples, the machine learning model may be retrained after a predefined number of new training datasets have been received.

Accordingly, certain embodiments may train a machine learning system to predict a user-specific likelihood of code use. The process 400 described above is provided merely as an example, and may include additional, fewer, different, or differently arranged steps than depicted in FIG. 4.

FIG. 5 depicts a block diagram of an exemplary process 500 for training and using a machine learning system to predict a user-specific likelihood of code use, according to certain embodiments. The machine learning system may include a machine learning model configured to predict a user-specific likelihood of code use. In some embodiments, the recommendation system 112 may one or more of generate, store, train, or use the machine learning model. The recommendation system 112 may include the machine learning model and/or instructions associated with the machine learning model, e.g., instructions for generating a machine learning model, training the machine learning model, using the machine learning model, etc. In other embodiments, a system or device other than the recommendation system 112 may be used to generate and/or train the machine learning model. For example, such a system may include instructions for generating the machine learning model and the training data, and/or instructions for training the machine learning model. A resulting trained machine learning model may then be provided to the recommendation system 112 for use.

As depicted in FIG. 5, in some examples, the process 500 may include a training phase 502, a deployment phase 510, and a monitoring phase 516. In the training phase 502, at step 506, the process 500 may include receiving and processing training data 504 to generate (e.g., build) a trained machine learning model 508 for predicting a user-specific likelihood of code use. The training data 504 may include a plurality of training datasets associated with a plurality of link sharing accounts. Each training dataset of the plurality of training datasets may be associated with a shared link having an associated code that was received by a respective user of a link sharing account in the past. An exemplary training dataset may include code information (e.g., a merchant, item, offer, and/or sharing user associated with the code), as well as an interaction history and a code use behavior of the respective user prior to the time the shared link was received that may be provided as inputs to train the machine learning model.

The training data 504 may be generated, received, or otherwise obtained from internal and/or external resources. For example, the interaction history may be retrieved from the interaction history data store 124 and/or may be retrieved directly from the financial account provider systems 114. The code use behavior and code information may be retrieved from the historical code use data store 122. The timestamps stored in association with each of the interaction history data and the code use behavior data may be used to curate the training datasets to ensure the interaction history and code use behavior included reflects only time periods prior to the time the sharing link was received.

Generally, a model includes a set of variables, e.g., nodes, neurons, filters, etc., that are tuned, e.g., weighted or biased, to different values via the application of the training data 504. In some examples, the training process at step 506 may employ supervised, unsupervised, semi-supervised, and/or reinforcement learning processes to train the model (e.g., to result in trained machine learning model 508). In some embodiments, a portion of the training data 504 may be withheld during training and/or used to validate the trained machine learning model 508.

When supervised learning processes are employed, labels or scores corresponding to the training data may facilitate the learning process by providing a ground truth. For example, the labels or scores may indicate whether the respective user actually used (e.g., redeemed) the code associated with the shared link. Training may proceed by feeding a training dataset, including code information associated with a past link received by a respective user, the respective user's interaction history up until the link was received, and the respective user's code use behavior up until the link was received, (e.g., a sample) from the training data 504 into the model, the model having variables set at initialized values, e.g., at random, based on Gaussian noise, a pre-trained model, or the like. The model may output a predicted likelihood that the respective user will use or redeem the code (e.g., a user-specific likelihood of code use) for the sample. The output may be compared with the corresponding label or score (e.g., the ground truth) indicating whether the respective user actually used or redeemed the past code to determine an error, which may then be back-propagated through the model to adjust the values of the variables. This process may be repeated for a plurality of samples at least until a determined loss or error is below a predefined threshold. In some examples, some of the training data 504 may be withheld and used to further validate or test the trained machine learning model 508.

For unsupervised learning processes, the training data 504 may not include pre-assigned labels or scores to aid the learning process. Rather, unsupervised learning processes may include clustering, classification, or the like to identify naturally occurring patterns in the training data 504. As one example, users may be clustered into groups based on identified similarities and/or patterns in interaction histories and/or code use behaviors of the users. K-means clustering or K-Nearest Neighbors may also be used, which may be supervised or unsupervised. Combinations of K-Nearest Neighbors and an unsupervised cluster technique may also be used. For semi-supervised learning, a combination of training data 504 with pre-assigned labels or scores and training data 504 without pre-assigned labels or scores may be used to train the model.

When reinforcement learning is employed, an agent (e.g., an algorithm) may be trained to make a decision regarding the user-specific likelihood of code use for the sample from the training data 504 through trial and error. For example, upon making a decision, the agent may then receive feedback (e.g., a positive reward if the predicted likelihood to use the code was above a predetermined threshold and the code was in fact used), adjust its next decision to maximize the reward, and repeat until a loss function is optimized.

Once trained, the trained machine learning model 508 may be stored (e.g., in the trained model data store 126) and subsequently applied by the recommendation system 112 during the deployment phase 510. For example, during the deployment phase 510, the trained machine learning model 508 executed by the recommendation system 112 may receive input data 512. The input data 512 may include the interaction history of a user associated with a sharing user of a link that is determined to be suitable to use the code, the code use behavior of the user, an information associated with the code itself. The machine learning model 508 may provide as output data 514 a predicted likelihood that the user will use (e.g., redeem) the code. The output data 514 may then be used by the recommendation system 112 to determine whether or not the user should be included in the list of receiving users recommended to the sharing user (not shown in FIG. 5). In examples where the trained machine learning model 508 is trained using clustering, when the trained machine learning model 508 is deployed, a user that is associated with the sharing user and determined to be suitable to use the code may be selected, and other users in the same cluster as the selected user may be identified and included in the list of receiving users.

If the user is included in the list of receiving users, and is selected by the sharing user, monitoring data 518 associated with the user's interactions with the code upon distribution of the link may be collected by the recommendation system 112 during the monitoring phase 516. The monitoring data 518 may include code interaction data, such as whether the user interacted with (e.g., clicked on) the link, an amount of time spent viewing webpage(s) associated with the link (e.g., indicative of the user's interest), whether the user used or redeemed the code associated with the link, and/or the like. During process 520, the monitoring data 518 may be analyzed along with the predicted output data 514 and input data 512 to determine an accuracy of the trained machine learning model 508. In some examples, based on the analysis, the process 500 may return to the training phase 502, where at step 506 values of one or more variables of the model may be adjusted to improve the accuracy of the training model.

The example process 500 described above is provided merely as an example, and may include additional, fewer, different, or differently arranged aspects than depicted in FIG. 5.

FIG. 5 describes the training, deployment, and monitoring associated with a trained machine learning model for predicting user-specific likelihood of code use (e.g., a first trained machine learning model). As described through the specification, one or more other trained machine learning models may be applied, such as the second trained machine learning model for predicting criteria associated with use of the code and/or the third trained machine learning model for predicting a likelihood of code reusability. Each of the second and third trained machine learning models may include similar training, deployment, and/or monitoring phases as described above for the first trained machine learning model in FIG. 5, however the particular types of training data, input data, output data, and monitoring data are different.

For example, for the second trained machine learning model, the training data may include a plurality of training datasets associated with a plurality of link sharing accounts. Each training dataset of the plurality of training datasets may be associated with a user of a link sharing account that attempted to use or redeem a code associated with a merchant in the past. An exemplary training dataset may include browsing history of the user with the merchant site, an interaction history of the user with the merchant, and/or code use behavior of the user specific to codes associated with the merchant, each prior to the time the user attempted to use or redeem the code, along with information associated with the code, including webpage content displayed when the attempted to redeem the codes. Each training dataset may also include or be associated with a label indicating whether the attempt to use or redeem the code was successful or not. The input data may include a browsing history of a given user for whom suitability is being determined with the merchant site, an interaction history of the given user with the merchant, code use behavior of the given user specific to codes associated with the merchant, and/or information associated with the codes. In one example, the output data may include a binary decision associated with a likelihood of whether the user will be able to use or redeem the code (e.g., whether the user is a suitable user). In another example, the input data may further include a set of one or more standard terms and conditions, and the output data may be a likelihood of the one or more standard terms and conditions being applicable to the given user. If the user is included in the list of receiving users, and is selected by the sharing user, the monitoring data may include information indicating whether the user was successful or not in redeeming the code, if attempted.

For the third trained machine learning model, the training data may include information (e.g., an item and/or an offer) for codes associated with the merchant that have been previously used or redeemed by one or more of the plurality of users of link sharing accounts to identify patterns for codes of the merchant, such as reusability and/or a maximum number of uses based on a type of the code. For example, for each of the plurality of users that redeemed a code of the merchant, were any of those codes later redeemed by another of the plurality of users and if so, how many times. Different models may be generated for different merchants. The input data may include an identifier of the merchant and information associated with the code (e.g., an item and/or an offer). The output data may include a likelihood that the code is reusable. In some examples, the output data may be in a binary format (e.g. 0 or 1, non-reusable or reusable). If the code is shared with multiple receiving users, the monitoring data may include information indicating whether or not the code shared by the sharing is successfully used or redeemed by more than one of the multiple receiving users.

FIG. 6 depicts an exemplary targeted sharing notification 608, according to certain embodiments. The targeted sharing notification 608, hereinafter notification 608, may be received from the link sharing system 110 via the link sharing application and displayed via a user interface of a browser (e.g., browser user interface 600) executing on the sharing user computing device 102. For example, the link sharing application may be a browser extension application that adds functionality, such as link sharing functionality, to the browser executing on the sharing user computing device 102. The browser may be directed to a webpage 602 of a merchant, such as a provider of a home meal delivery service. The webpage 602 may include a link 604 for sharing, as shown in browser user interface 600. For example, the webpage 602 may be a referral webpage the browser is directed to following a completion of an interaction between the sharing user and the merchant. The webpage 602 may include a prompt 606 for the sharing user to share the link 604. In some examples, the prompt 606 may include a bonus, offer, reward, or other similar incentive provided to the sharing user for sharing the link 604.

The link sharing system 110 may be configured to detect the link 604 via the link sharing application, and may perform targeted link sharing (e.g., perform one or more steps of the process 200 and/or the process 300) to generate the notification 608 that includes a list 610 of recommended receiving users of the link 604. Each receiving user included in the list 610 is associated with the sharing user, is suitable (e.g., eligible or qualified) for using a code associated with the link 604, and has an ML-predicted likelihood of code use that meets a predefined criterion. The notification 608 may include a first prompt 612 for the sharing user to select one of the receiving users from the list 610.

In some examples, the notification 608 may have alternative prompts, such as a second prompt 614 and a third prompt 616. The second prompt 614 may provide the sharing user an option to share the link 604 with another user who is not included in the list 610. The second prompt 614 may be accompanied by a text box to enable the sharing user to input contact information of the other user. In other examples, the second prompt 614 may be accompanied by a drop down menu for selecting among associated users and/or contact information for the associated users that are automatically displayed. For example, the information for the associated users may be retrieved from the account profile data store 118 and/or the optional social network graph data store 128, and automatically displayed within the drop down menu. The third prompt 616 may provide the sharing user an option to share the link 604 with all users that are associated with the sharing user (e.g., a select all option).

In some examples, the link sharing system 110 may automatically extract or copy the link 604 from the webpage 602 for inclusion in the notification 608, as shown. Additionally, the notification 608 may include a copy control element 618 that enables the sharing user to copy the automatically extracted link. Copying of the link may enable the sharing user to distribute the link independently of link sharing system 110 through personal communication channels, such as electronic mail, text message, instant message, etc. In other examples, the link sharing system 110 may be unable to automatically extract the link 604 (e.g., if the link 604 is not publicly visible on the webpage 602), and the notification 608 may provide a text box that enables the user to manually paste the link 604 into the text box for distribution by the link sharing system 110.

The notification 608 may also include a text box 620 to enable the sharing user to input a personalized message to the one or more selected receiving users. For example, the message from the sharing user may tell the receiving users why they love the meal delivery service subscription to entice the receiving users to use or redeem the code associated with the link to purchase a subscription themselves. The notification 608 may further include a display control element 622 that allows the sharing user to select whether or not the link sharing system 110 displays notifications to the sharing user when links for sharing are detected, such as the notification 608 on the webpage 602 (e.g., allows the sharing user to opt in or out of receiving notifications).

Once the sharing user has selected one or more receiving users from the list 610 and/or one or more other users to share the link with (e.g., using one of the alternative selection options), the sharing user may then select a share control element 624 of the notification 608 to cause the link to be distributed to respective computing devices of the selected receiving users. In this example, the first receiving user and the second receiving user are selected from the list 610, and the link may be distributed to the first receiving user computing device 104A and the second receiving user computing device 104B, respectively.

The notification 608 described above is provided merely as an example, and may include additional, fewer, different, or differently arranged information and/or interactive control elements than depicted in FIG. 6.

FIGS. 7A and 7B depict exemplary non-reusable link notifications 700, 750, according to certain embodiments. As described in detail with reference to step 320 of the process 300 of FIG. 3, when at least two receiving users are selected for sharing the link, the link sharing system 110 may determine whether the code associated with the link is reusable. If the code is determined to be non-reusable (or is determined to be a limited use reusable code with a greater number of selected receiving users than number of uses), then a proactive non-reusable link notification 700 and/or a reactive non-reusable link notification 750 may be generated and provided to the sharing user.

FIG. 7A depicts the proactive non-reusable link notification 700, hereinafter notification 700. The notification 700 may be displayed subsequent to the sharing user's selection of the share control element 622 shown in FIG. 6 when at least two receiving users are selected and the link is determined to be non-reusable. In some examples, the notification 700 may be displayed on the webpage 602 that is navigated to on the browser of the sharing user computing device 102, similar to the notification 608 in FIG. 6. The notification 700 may include an indicator 702 that the code associated with the link 604 has been determined by the link sharing system 110 to be a non-reusable code. Optionally, the notification 700 may also request a confirmation 704 from the sharing user as to whether the non-reusable determination was correct.

Based on the code being non-reusable, the notification 700 may include a first prompt 706 asking for the sharing user to proactively provide one or more new links with one or more associated new codes (e.g., depending on the number of receiving users) to enable each of the receiving users to have a unique code that is not invalidated when another of the receiving users redeems their code. For example, based on the sharing user's interactions with the merchant, the sharing user may have accrued multiple links that may be provided as the new links. The notification 700 may include one or more text boxes 708 into which the sharing user may paste the new links into. In some examples, the link sharing system 110 may be configured to save the accrued links in association with the sharing user's link sharing account, and may automatically select the new link from the saved links upon a request or other indication from the sharing user to add the new link. Additionally, the notification 700 may include a second prompt 710 that provides the sharing user an alternative option to select if the sharing user does not have any new links to share.

Once the new links have been added and/or the user has selected the alternative option indicating that they do not have any new links to share, the sharing user may select a share control element 712 of the notification 700 to cause distribution of the links by the link sharing system 110. Continuing the example where the first and second receiving users are selected to share the link with, if a new link is provided by the sharing user, the link sharing system 110 may distribute the link 604 to the first receiving user computing device 104A of the first receiving user and the new link to the second receiving user computing device 104B of the second receiving user. Otherwise, if the user has selected the alternative option indicating that they do not have any new links to share, the link sharing system 110 may distribute the link 604 to both the first and second receiving user computing devices 104A, 104B.

FIG. 7B depicts the reactive non-reusable link notification 750, herein after notification 750, that may be displayed subsequent to one of the receiving users using or redeeming the code associated with the shared link such that the code is now invalid. In some examples, the notification 750 may be displayed on a web browser of the sharing user computing device (e.g., if and/or when the web browser is next launched) via a browser extension version of the application. In other examples, the notification 750 may be provided as an electronic communication to the sharing user (e.g., a push notification to a local version of the link sharing application executing on the sharing user computing device 102, an email, a text message, and instant message).

The notification 750 may include an indicator 752 that the code associated with the link 604 has been redeemed by one of the receiving users (e.g., the first receiving user). Based on the non-reusable code now being invalid due to the redemption by first receiving user, the notification 750 may include a first prompt 754 asking for the sharing user to reactively provide one or more new links with one or more associated new codes (e.g., depending on the number of receiving users) to enable each of the remaining receiving users, such as the second receiving user, to be able to use or redeem a similar offer or deal associated with the link. The notification 750 may include one or more text boxes 756 into which the sharing user may paste the new links into and/or which the link sharing system 110 may automatically populate with an accrued and saved link as previously discussed with reference to the notification 700.

In some examples, the notification 750 may request a confirmation 758 from the sharing user as to which remaining one or more receiving users (e.g., which of the receiving users selected by the sharing user that were not the first to redeem the code) to share the new links with. Additionally, the notification 750 may provide a second prompt 760 that provides the sharing user an option to select one or more other users to share the link with (e.g., other users not initially selected to receive the link via the notification 608). The second prompt 760 may be accompanied by a text box enabling the sharing user to input contact information of the other user(s). In other examples, the second prompt 760 may be accompanied by a drop down menu for selecting among associated users and/or contact information for the associated users that are automatically displayed. For example, the information for the associated users may be retrieved from the account profile data store 118 and/or the optional social network graph data store 128, and automatically displayed within the drop down menu.

Once the sharing user has added one or more new links and has confirmed which remaining receiving users and/or selected other users to share the link with, the sharing user may select a share control element 762 of the notification 750 to cause distribution of the new links to respective computing devices of the confirmed and/or selected users.

The notifications 700, 750 described above are provided merely as examples, and may include additional, fewer, different, or differently arranged information and/or interactive control elements than depicted in FIGS. 7A and 7B.

FIG. 8 depicts an exemplary shared link notification 804, according to certain embodiments. The shared link notification 804, hereinafter notification 804, may be received from the link sharing system 110 via the link sharing application and displayed via a user interface of a browser (e.g., browser user interface 800) executing on one of the receiving user computing devices 104. For example, the application may be a browser extension application that adds functionality, such as link sharing functionality, to the browser executing on the receiving user computing device 104.

After the link sharing system 110 has distributed the link 604 and/or multiple links (e.g., the link 604 and one or more new links) to the selected receiving users, the link sharing system 110 may monitor web browser activity of the receiving users. The notification 804 may be displayed in response to detecting navigation to any webpage of the site of the merchant associated with the link, such as a home webpage 802 of the merchant site, via the web browser executing on the receiving user computing device 104. Display of the notification 804 while the receiving user is currently navigated to the merchant site (e.g., while the receiving user may already be in a mindset to interact with the merchant) may increase engagement with the notification 804, and thus increase a likelihood that the receiving user redeems the code associated with the link 604 that is included within the notification 804.

In addition to the link 604, the notification 804 may include a first prompt 806 indicating that the link 604 (e.g., a referral link) has been shared and redemption of a code associated with the link 604 may provide the receiving user with an offer, deal, discount, or other similar incentive. The notification 804 may also include a copy control element 808 and a redeem control element 810. Selection of the copy control element 808 may automatically copy the link 604. In some examples, once copied, the receiving user may manually navigate to a webpage of the merchant site that is associated with the link 604 to proceed with the redemption process by pasting the copied link 604 into the web browser in the same or a new browser tab. Alternatively, the receiving user may paste the copied link 604 into another source (e.g., an electronic communication and/or a document). Selection of the redeem control element 810 may automatically navigate the web browser to the webpage of the merchant site that is associated with the link 604 in the same or a new browser tab to enable the receiving user to proceed with the redemption process.

The notification 804 may further include a display control element 812 that allows the receiving user to select whether or not the link sharing system 110 displays notifications to the receiving user when navigating websites associated with shared links received by the user, such as the notification 804 on the home webpage 802 (e.g., allows the receiving user to opt in or out of receiving notifications of this type).

The notification 804 described above is provided merely as an example, and may include additional, fewer, different, or differently arranged information and/or interactive control elements than depicted in FIG. 8.

FIG. 9 depicts another exemplary shared link notification 904, according to certain embodiments. The shared link notification 904, hereinafter notification 904, may be received from the link sharing system 110 via the link sharing application and displayed via a user interface of a browser (e.g., browser user interface 900) executing on one of the receiving user computing devices 104. For example, the application may be a browser extension application that adds functionality, such as link sharing functionality, to the browser executing on the receiving user computing device 104.

After the link sharing system 110 has distributed the link 604 and/or multiple links (e.g., the link 604 and one or more new links) to the selected receiving users, the link sharing system 110 may monitor web browser activity of the receiving users. While monitoring, the link sharing system 110 may detect that search results of a search engine executing on the receiving user computing device 104 include the merchant website. In response to such detection, the notification 804 may be displayed as an embedded notification within a search results page 902 on the browser user interface 900. The notification 904 may be displayed in association with (e.g., adjacent to, underneath, etc.) the merchant website within the search results provided on the search results page 902.

The notification 904 may include the same or similar features as the notification 804 described in detail with reference to FIG. 8. For example, the notification 904 may include the link 604, the first prompt 806, the copy control element 808, and the redeem control element 810. Although not shown, the notification 904 may also include a display element similar to display control element 812 that allows the receiving user to select whether or not the link sharing system 110 displays notifications embedded within search results, such as the notification 904 on the search results page 902 (e.g., allows the receiving user to opt in or out of receiving notifications of this type).

The notification 904 described above is provided merely as an example, and may include additional, fewer, different, or differently arranged information and/or interactive control elements than depicted in FIG. 9.

In general, any process or operation discussed in this disclosure that is understood to be computer-implementable, such as the processes or operations depicted in FIGS. 2-9, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

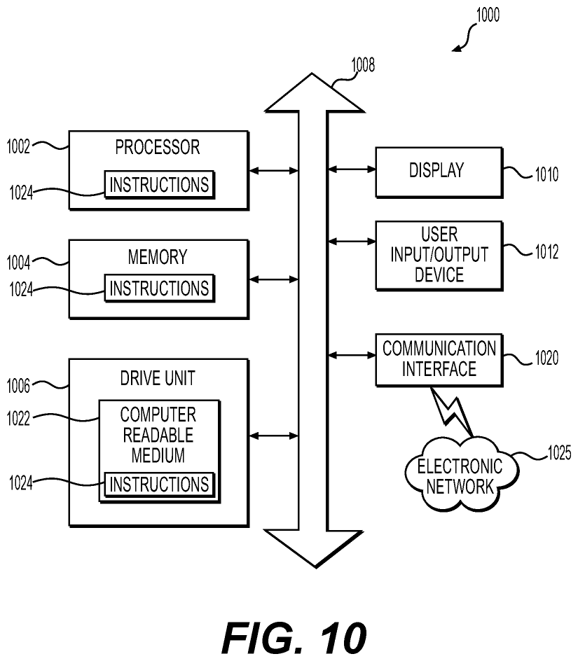

FIG. 10 depicts an example of a computer 1000, according to certain embodiments. FIG. 10 is a simplified functional block diagram of a computer 1000 that may be configured as a device for executing processes or operations depicted in, or described with respect to, FIGS. 2-9, according to exemplary embodiments of the present disclosure. For example, the computer 1000 may be configured as one of the sharing user computing device 102, receiving user computing devices 104, one of the server-side systems 108, and/or another device according to exemplary embodiments of this disclosure. In various embodiments, any of the systems herein may be a computer 1000 including, e.g., a data communication interface 1020 for packet data communication. The computer 1000 may communicate with one or more other computers 1000 using the electronic network 1025. The electronic network 1025 may include a wired or wireless network similar to the network 106 depicted in FIG. 1.

The computer 1000 also may include a central processing unit (“CPU”), in the form of one or more processors 1002, for executing program instructions 1024. The program instructions 1024 may include instructions for running the link sharing application associated with the link sharing system 110 (e.g., if the computer 1000 is sharing user computing device 102 and/or one of the receiving user computing devices 104). The program instructions 1024 may include instructions for running one or more operations of the server-side systems 108 (e.g., if the computer 1000 is a server device or other similar computing device of one or more of the respective server-side systems 108). The computer 1000 may include an internal communication bus 1008, and a drive unit 1006 (such as read-only memory (ROM), hard disk drive (HDD), solid-state disk drive (SDD), etc.) that may store data on a computer readable medium 1022, although the computer 1000 may receive programming and data via network communications. The computer 1000 may also have a memory 1004 (such as random access memory (RAM)) storing instructions 1024 for executing techniques presented herein, although the instructions 1024 may be stored temporarily or permanently within other modules of computer 1000 (e.g., processor 1002 and/or computer readable medium 1022). The computer 1000 also may include user input and output ports 1012 and/or a display 1010 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features. For example, while some of the embodiments above pertain to training and/or using one or more trained machine learning models for targeted link sharing, any suitable activity may be used.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for targeted link sharing, comprising:
detecting a link for sharing on a computing device associated with a sharing user;
determining one or more users from a plurality of users associated with the sharing user that are suitable for using a code associated with the link;
for each of the one or more users:
providing an interaction history of the respective user, a code use behavior of the respective user, and information associated with the code as inputs to a trained machine learning system;
receiving a likelihood that the respective user uses the code as output of the trained machine learning system; and
determining whether the output meets a predefined criterion;
generating a list of receiving users that includes each of the one or more users determined to have the output meet the predefined criterion;
generating and providing a first notification including the list for display on the computing device associated with the sharing user;
in response the first notification, receiving a selection of at least a first receiving user and a second receiving user of the one or more receiving users from the list to share the link with;
determining the code is a non-reusable code;
generating and providing a second notification indicating the code is non-reusable;
in response the second notification, receiving a new link including a new code;
distributing the link to a first computing device associated with the first receiving user and the new link to a second computing device associated with the second receiving user; and
causing one or more of the first computing device or the second computing device to dynamically display a notification including at least one of: the link on a web browser executing on the one or more of the first computing device or the second computing device in response to detecting navigation to a site associated with a merchant providing the link on the web browser, or the link as an embedding within search results of a search engine executing on the one or more of the first computing device or the second computing device in response to detecting the search results include a site associated with a merchant providing the link.

2. The computer-implemented method of claim 1, wherein determining the one or more users that are suitable for using a code associated with the link comprises:
identifying criteria for using the code; and
determining the one or more users from the plurality of users based on a comparison of the criteria to a plurality of interaction histories of the plurality of users.

3. The computer-implemented method of claim 2, wherein identifying the criteria comprises:
parsing one or more terms and conditions associated with the code to identify the criteria.

4. The computer-implemented method of claim 3, wherein the one or more terms and conditions include one or more of: no interaction history with a merchant associated with the code, no interaction history with the merchant within a predefined period of time, no interaction history with the merchant with respect to an item associated with the code, or no previous use of an offer associated with the code.

5. The computer-implemented method of claim 2, wherein identifying the criteria comprises:
applying another trained machine learning system to predict the criteria.

6. The computer-implemented method of claim 1, wherein the interaction history of the respective user includes information associated with one or more of a timing of interactions, a frequency of interactions, or a proportion of interactions among a plurality of merchants.

7. The computer-implemented method of claim 1, wherein the code use behavior of the respective user includes information associated with past codes received by the respective user and an indication of whether the past codes are used, the information associated with the past codes including one or more of: merchants associated with the past codes, items associated with the past codes, offers associated with the past codes, sharing users that shared the past codes, a total number of the past codes received, a total number of past codes used, a frequency at which the past codes were used, a number of times the respective user further shared the past codes to other users, or a number of the other users that used the past codes further shared by the respective user.

8. The computer-implemented method of claim 1, wherein the information associated with the code includes one or more of a merchant, an item, an offer, or the sharing user associated with the code.

9. The computer-implemented method of claim 1, wherein determining whether the output meets the predefined criterion includes one or more of:
determining whether the likelihood that the respective user uses the code meets or exceeds a predefined threshold; or
determining whether the likelihood that the respective user uses the code is a top N^{th} likelihood among the one or more users determined to be suitable to use the link.

10. The computer-implemented method of claim 1, wherein determining the code is non-reusable comprises one or more of:
parsing one or more terms and conditions associated with the code to determine whether the code is a reusable code;
applying another trained machine learning system to predict a likelihood that the code is a reusable code; or
receiving an indication of whether the code is a reusable code as input from the sharing user in response to a prompt provided for display on the computing device.

11. The computer-implemented method of claim 1, further comprising:
detecting one or more of use of the code by the first receiving user or use of the new code by the second receiving user; and
in response to the detection, generating and providing a third notification to the computing device associated with the sharing user to indicate one or more of the use of the code or the new code.

12. A computer-implemented method for targeted link sharing, comprising:
detecting a link for sharing on a computing device associated with a sharing user;
identifying criteria for using a code associated with the link;
determining one or more users from a plurality of users associated with the sharing user that are suitable to use the link based on the criteria and a plurality of interaction histories of the plurality of users;
for each of the one or more users:
providing an interaction history of the respective user, a code use behavior of the respective user, and information associated with the code as inputs to a trained machine learning system;
receiving a likelihood that the respective user uses the code as output of the trained machine learning system; and
determining whether the output meets a predefined criterion;
generating a list of receiving users that includes each of the one or more users determined to have the output meet the predefined criterion;
providing a notification including the list for display on the computing device associated with the sharing user;
receiving a selection of at least one of the one or more receiving users from the list to share the link with;
distributing the link to at least one computing device associated with the at least one of the one or more receiving users; and
causing the at least one computing device to dynamically display a notification including at least one of: the link on a web browser executing on the at least one computing device in response to detecting navigation to a site associated with a merchant providing the link on the web browser, or the link as an embedding within search results of a search engine executing on the at least one computing device in response to detecting the search results include a site associated with a merchant providing the link.

13. The computer-implemented method of claim 12, wherein identifying the criteria comprises one or more of:
parsing one or more terms and conditions associated with the code to identify the criteria; or
applying another trained machine learning system to predict the criteria.

14. The computer-implemented method of claim 12, further comprising:
determining a type of the code, including determining whether the code is a reusable code, by one or more of:
parsing one or more terms and conditions associated with the code to determine whether the code is a reusable code;
applying another trained machine learning system to predict a likelihood that the code is a reusable code; or
receiving an indication of whether the code is a reusable code as input from the sharing user in response to a prompt provided for display on the computing device.

15. The computer-implemented method of claim 14, wherein:
the code is determined to be a non-reusable code,
the at least one of the one or more receiving users selected include a first receiving user and a second receiving user,
the link is distributed to a first computing device associated with the first receiving user and a second computing device associated with the second receiving user, and
the method further comprises:
detecting use of the code by the first receiving user;
based on the code being non-reusable, generating and providing another notification for display on the computing device associated with the sharing user, the notification indicating the use of the code by the first receiving user;
in response to the other notification, receiving a new link including a new code; and
distributing the new link to the second computing device associated with the second receiving user to replace the link.

16. The computer-implemented method of claim 14, wherein:
the code is determined to be a non-reusable code,
the at least one of the one or more receiving users selected include a first receiving user and a second receiving user, and
the method further comprises:
generating and providing another notification indicating the code is non-reusable;
in response the other notification, receiving a new link including a new code; and
distributing the link to a first computing device associated with the first receiving user and the new link to a second computing device associated with the second receiving user.

17. The computer-implemented method of claim 12, further comprising:
detecting use of the code by the at least one of the one or more receiving users; and
in response to the detection, generating and providing another notification to the computing device associated with the sharing user to indicate the use of the code.

18. (canceled)

19. (canceled)

20. A method for training a machine learning system to predict a likelihood of code use, the method comprising:
receiving a plurality of training datasets associated with a plurality of users, each of the plurality of training datasets including an interaction history and a code use behavior of a respective user of the plurality of users, information associated with a past code received by the respective user, and an indication of whether the past code was used;
providing at least a portion of the plurality of training datasets as input to a machine learning system to train the machine learning system to predict a user-specific likelihood of code use, wherein responsive to detecting a link including a current code for sharing on a computing device associated with a sharing user, the trained machine learning system is deployed to predict a likelihood of use of the current code for each of one or more users that are associated with the sharing user and are determined to be suitable to use the code;
receiving feedback associated with at least one of the one or more users that the sharing user selected to share the current code with, the feedback indicating whether the current code was used; and
updating the trained machine learning system based on the feedback.
